(19) United States
(12) Patent Application Publication
(10) Pub. No.: US 2019/0146493 A1
(43) Pub. Date: May 16, 2019

(54) Method And Apparatus For Autonomous System Performance And Benchmarking

(71) Applicant: GM GLOBAL TECHNOLOGY OPERATIONS LLC, Detroit, MI (US)

(72) Inventors: Matthew E. Phillips, Calabasas, CA (US); Michael J. Daily, Thousand Oaks, CA (US); Jaehoon Choe, Agoura Hills, CA (US); Nandan Thor, San Luis Obispo, CA (US); Dylan T. Bergstedt, Sherman Oaks, CA (US)

(21) Appl. No.: 15/811,885

(22) Filed: Nov. 14, 2017

(51) Int. Cl. G05D 1/00; G05D 1/02

(52) U.S. Cl. CPC G05D 1/0088; G05D 1/021

(57) ABSTRACT

The present application generally relates to methods and apparatus for evaluating and assigning a complexity metric to a driving scenario. More specifically, the application teaches a method and apparatus for breaking a scenario into subtasks, assigning each subtask a complexity value and generating an overall complexity metric in response to a weighted combination of the subtask complexities as well as human-perceived task complexity.

### BACKGROUND

The present disclosure generally relates to vehicles, and more particularly relates to methods and radar systems for tracking information based on adaptive detectors.

The present application generally relates to vehicle control systems and autonomous vehicles. More specifically, the application teaches a method and apparatus for evaluating and quantifying the complexity of events, situations, and scenarios developed within simulation as a measure to assess, and subsequently train, a cognitive model of autonomous driving.

### BACKGROUND INFORMATION

In general, an autonomous vehicle is a vehicle that is capable of monitoring external information through vehicle sensors, recognizing a road situation in response to the external information, and manipulation of a vehicle owner. Autonomous vehicle software is tested, evaluated and refined by running the software against various test scenarios to determine the performance of the software and the frequency of success and failure. However, some scenarios are more complex than others, so a 99% success rate at a less complex scenario may not be better than a 98% success rate in a more complex scenario. Therefore, it is desirable to be able to quantify a complexity measure for a driving scenario in order to determine an accurate performance metric for an autonomous vehicle control system.

The above information disclosed in this background section is only for enhancement of understanding of the background of the invention and therefore it may contain information that does not form the prior art that is already known in this country to a person of ordinary skill in the art.

### SUMMARY

Embodiments according to the present disclosure provide a number of advantages. For example, embodiments according to the present disclosure may enable testing of autonomous vehicle software, subsystems and the like rapidly with only periodic human intervention. This system may further be employed to test other control system software and is not limited to autonomous vehicles.

In accordance with an aspect of the present invention, an apparatus comprising a sensor interface for generating sensor data for coupling to a vehicle control system, a control system interface for receiving control data from the vehicle control system, a memory for storing a first scenario having a first overall complexity wherein the first scenario is divided into a first subtask and a second subtask and wherein the first subtask has a first complexity and the second subtask has a second complexity and wherein the first overall complexity is determined in response to the first complexity and the second complexity, and a simulator for simulating a driving environment in response to the first scenario and the control data, the simulator further operative to control the sensor interface and to generate performance data in response to the control data.

In accordance with another aspect of the present invention, a method comprising receiving a driving scenario, segmenting the driving scenario into a first task and a second task, assigning a first complexity to the first task and a second complexity to the second task, generating an overall complexity in response to the first complexity and the second complexity, comparing the overall complexity to a human complexity, weighting the first complexity and the second complexity in response to the comparison such that the overall complexity correlates with the human complexity to generate an updated overall complexity, and evaluating a driver performance in response to the updated overall complexity.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary left turn scenario according to an embodiment.

FIG. 2 is an exemplary apparatus for implementing the method for autonomous system performance metric generation and benchmarking according to an embodiment.

FIG. 3 is an exemplary method for autonomous system performance metric generation and benchmarking according to an embodiment.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. For example, the algorithms, software and systems of the present invention have particular application for use on a vehicle. However, as will be appreciated by those skilled in the art, the invention may have other applications.

Driving complexity is typically measured in relation to specific scenarios along with the rules of the road and goals of driving. For example, in a left turn scenario, the timing of the decision to execute the left turn at a T-junction is a critical moment with numerous contributing complexity factors which ultimately contribute to the resultant behaviors and outcomes. In another exemplary scenario, a driver or pedestrian in or near a stopped vehicle may wave traffic by if the car is blocking a portion of the road. Successful navigation of the stopped car and oncoming traffic requires the driver to observes, assess, and judge the manifold factors and potential dangers based upon other drivers' behavior while negotiating this complex situation.

In determining and quantifying driving complexity it is desirable to emphasize the development, parametric variations, and quantification of scenarios where current Al or deep-learning based autonomous driving systems have the poorest performance. Complexity can also be quantified theoretically and measured in a variety of ways. For example, certain behavioral measures allow researchers to quantify driving performance, such as vehicle distance to center of the lane, or following distance to other traffic. In addition, a human's performance on a driving task can be assessed with behavioral and neurophysiological metrics of engagement, performance, and factors contributing to lower performance. The behavioral measures include reaction time for decisions and behaviors including perceptual detection, discrimination, and time on task.

Typical driving failures result from human error and procedural failures. Neural measures using electroencephalograms and other non-invasive brain imaging techniques include cognitive workload, engagement and the cognitive state of the operator, such as fatigue, spatial attention etc., in the subtask processes. The driving control inputs can also be used to assess the performance given a target or ideal condition, decision, or path (e.g. motor tracking errors). The driver's prior experience and access to the experience and knowledge are also critical factors in decision making performance. The decision processes for drivers in highly complex situations are a specific emphasis for the design of the scenarios and the complexity and grading metrics of both human in loop (HIL) and autonomous driving examples from these scenarios. The goal is to initially train the cognitive model using the “best” HIL examples of the complex scenarios, and then to generate good and bad training data using an autonomous control system and grading the subsequent exemplars rapidly in parallel via sufficiently powerful hardware, such as a computing cluster.

In research concerning HIL driver behavior and traffic safety, complexity measures are often derived to quantify the difficulty of traffic situations and assess performance. This depends on a number of environmental factors, and metrics such as traffic density, driver agent behavior, occupancy and mean speed ground truths as generated by traffic control cameras, and overall configuration of traffic, roads, and percept qualia. In order to train the cognitive driving system, all of these variables must be manipulated in automated fashion in order to create a rich library of scenarios from which to generate accurate semantic information and generate novel behaviors that meet or exceed the capability of human drivers. An example of such a system would utilize a sweep of these parameters to produce scenarios of varying complexity and provide rapid iterations and variations to scenarios infeasible in real-world driving contexts.

While this approach would enable rapid testing and simulation of a wide variety of driving scenarios beneficial to the training of a cognitive model, it also presents unique challenges to overcome. Because scenarios are generated in unsupervised fashion in great quantity, it becomes infeasible to determine the difficulty and complexity of a given scenario if conventional human scoring methods are used. With potentially tens of thousands of scenarios can be generated by these methods, the ability to automatically quantify the complexity measures, comparable to perceived complexity by humans, become critical to determine the objective performance of cognitive system relative to HIL driver behavior. This is not the only issue associated with rapid training of cognitive systems via massively parallel simulation; as driving scenarios become more realistic and practical, the means by which the complexity is determined likewise becomes more challenging.

Within a scenario, an ‘episode’ is defined as a discrete set of ‘events’ and is the top-level hierarchy of the cognitive system. The episode can be considered the basic unit of memory within the cognitive system that define sequences of continuous phenomena that describe an instance of some vehicular scenario, e.g. a left turn at a busy intersection. A complete episode is comprised of smaller sequences called ‘events,’ which are specific, stereotyped occurrences that may be shared across multiple episodes. In the example above, some events comprising the episode can include items such as the velocity of cross traffic, available gaps within the traffic, trajectory of other vehicles/pedestrians, or the current lane position of the self-vehicle. Such discretized phenomena are not necessarily unique to the circumstances of the left turn event, and could be present in other episodes; for example, pedestrians may be present in an episode describing a parking scenario. Moreover, these subunits of a scenario may be scored or rated with a complexity value, but these values may not be static, or transfer interchangeably to the same event contained within a different scenario; as an example, the criticality of a mid-left turn event may be altered due to the presence of heavy traffic immediately following the turn. That is, depending on the context of an event, the complexity of the event or the overall scenario may be altered. Methods to automatically score such scenarios must, therefore, necessarily have the ability to account for these variations and weight and assess scenario subunits accordingly.

Each event is defined by percepts, or observations taken from the environment by data provided by internal and external sensor systems. These percepts are collected as ‘tokens’ and consist of a package of data streamed from sensor systems in real time. These data are then processed and used to define events. Percepts include critical information about the world, such as lane positions, turn lanes, and other environmental conditions integral to the act of driving. Also integral are properties of agents within that world, such as object definition, velocity, heading, etc., and aspects of the self vehicle, such as self velocity, heading, etc. Tokens are streaming percepts that are assembled to define discrete units of scenario states, called events. Then, a collection of observed events are learned through real-world driving and simulation to generate end-to-end scenarios called episodes, which are stored as the major units of memory.

It is desirable to learn as many episodes as possible which is more feasible through passive collection through real-world driving scenarios because of the nature of the cognitive processor. As a result, scenarios have been produced that allow rapid iteration of various world states, such as road lane configuration, traffic scenarios, self-vehicle properties, and non-self agent behaviors for faster-than-real time storage of episodes. This allows for a much richer episodic memory bank, and provides a more extensive library of scenarios from which the cognitive system can undergo machine learning and generate semantic relationships, critical for generative, non-ruIe-based agency.

During simulation, tokens may be generated in real-time via streaming of percepts through an interface. Vehicular and environmental data are collected per simulation step and streamed to an output socket for collection into the cognitive model, which then packages collected token data into events. Percepts may be collected from vehicle ‘self port’ data, and be tokenized in a per-vehicle basis, providing an allo-centric position/velocity array of every agent within the scenario. Environmental states, such as road configurations, are reconstructed in the cognitive model through data collected from lane marker sensors which defined the edges of valid lanes and provides information about intersections or thoroughfare configurations that are learned as components of episodes by the cognitive system. Non ground truth devices may be tokenized on a per-device basis. The ‘sensor-world’ will then take the place of ground-truth self-port data, and be subject to realistic perturbations of the percept stream, such as sensor occlusion, malfunction, or signal attenuation due to environmental factors such as rain or fog. Delineation of individual events and episodes will at first be facilitated by the production of scenarios in simulation. With the rapid collection and automation of varying events through parameter sweeps of simulation variables (e.g. lane number), the cognitive system will eventually define the temporal edges of events through utilization of grammar algorithms and hierarchical clustering techniques.

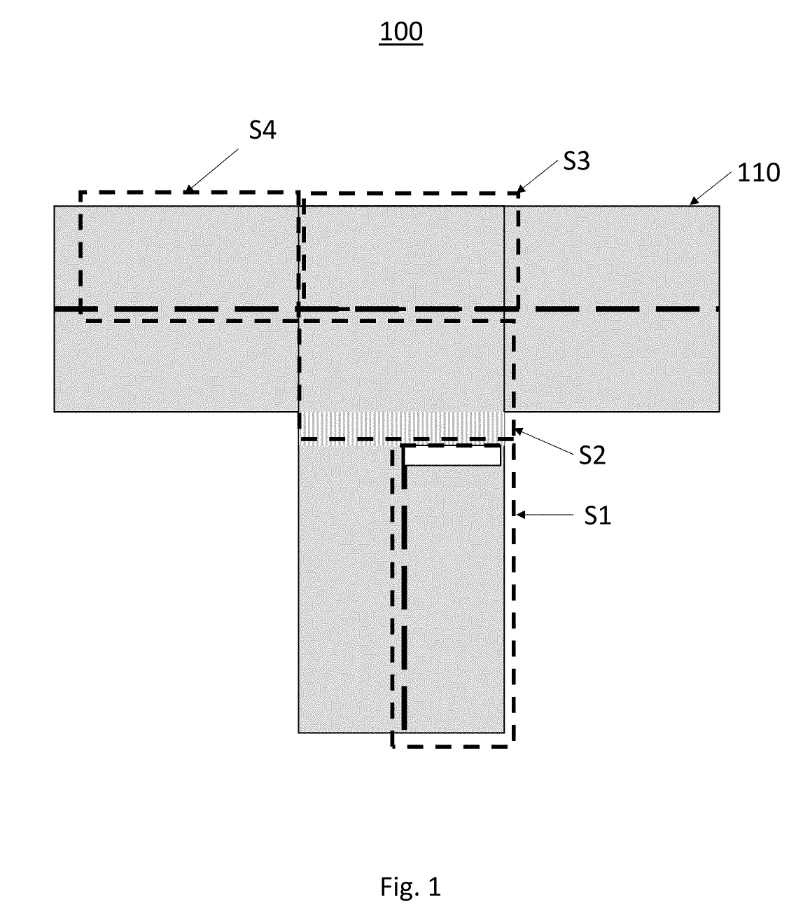

Turning now to FIG. 1, an exemplary left turn scenario is shown. In order to generate an accurate and meaningful complexity metric, the scenario is divided into subtasks. The t junction road surface 110 is shown where a vehicle approaches from the lower road S1 and navigates a left turn across one lane of traffic. The introduction of a complexity metric allows a complexity value to be computed at the subtask level during an autonomous driving task. By taking data that is generated during simulation and extracting a measure of complexity, the autonomous vehicle creates a basis for scenario comparison and a basis for taking action based on previous situations with similar complexity scores. Attentional demand of the autonomous system can then be based on complexity. The complexity measure ultimately feeds in to the cognitive model, along with grading scores, to guide decision making. In this exemplary embodiment, the evaluation is performed on a left hand turn scenario. Within this scenario there are many iterations that can occur based on, for example, traffic density, number of pedestrians, weather conditions, etc. In order to measure complexity, the main task of making a left-hand turn is broken down into subtasks. In this exemplary embodiment, the main task of making a left turn is broken up into four subtasks S1, S2, S3 and S4. In order to allow for scalability to other scenarios, features of the subtasks are found to build a set of guidelines to break the data into subtasks. Subtask 1's S1 endpoint is determined by finding the time point where the car's velocity drops below a certain acceptable stopping speed. Subtask 2's S2 endpoint is then found when the car exceeds a certain acceleration velocity. Subtask 3's S3 endpoint is located by looking at when the x-coordinate of the car stops changing. It is assumed that the endpoint of one subtask is the beginning point of the next subtask. These features that determine the end of respective subtasks should be scalable to most simple left-turn scenarios but it will depend on the aggressiveness of the driver, familiarity with the road, and simplicity of the left turn task.

The purpose of breaking the left-turn task into subtasks is to determine complexity changes based on where in the task complexity is measured. By splitting the task into subtasks, it is possible to see how complexity changes among different parts in the task but also how complexity changes over time. By chunking the task into subtasks, complexity can be calculated within each subtask and complexity can be calculated among subtasks as a function of time. Inherently, complexity changes from subtask 1 S1 to subtask 2 S2 demonstrate a difference in complexity over time. However, within a subtask, features are generally the same, so measuring differences among subtasks gives a non-trivial temporal difference in complexity. Generally, subtasks are determined based on difference of features, which allows for a natural temporal complexity comparison between subtasks. Certainly, there may be some features that change within a subtask but fundamental to how subtasks are broken down is a minimization of those feature changes. Depending on the application, it may be of interest to measure how complexity changes temporally throughout the entire task or exclusively in one subtask. Since subtasks are continuous (the endpoint of one is the starting point of the next), both large-scale (throughout a task) and small-scale (throughout a subtask) temporal complexity can be calculated and we postulate that our future efforts will extrapolate these complexity measures to a continuous or discrete event-related time domain.

Specific features calculated from the data from the simulations are used to map to the complexity parameters. For example, the weather can play a very important role in determining perceptual complexity and to a lesser degree, the speed of decision making. A direct way to measure the number of alternatives, and therefore estimate the complexity, is to measure the mean number of lanes in each subtask. Counting the number of lanes may be a direct measure of complexity in this left turn scenario as it indicates approaching an intersection, where there are a large number of alternatives. However, the number of lanes may not be as indicative of complexity in other situations such as a multi-lane highway may have four lanes in each direction but it may not be as complex as even a two way intersection. The number of lanes may only be important at lower speeds, which means that the interaction between the speed feature and the number of lanes feature may need to be considered in the future. The fundamental idea behind using the number of lanes in this scenario is that it (1) indicates an intersection in this scenario and (2) indicates a choice of lanes to merge into. In this way, counting the number of lanes can be used to compute complexity. Another measure of the number of alternatives can be taken in a temporal dimension, as opposed to a spatial dimension. In that regard, the number of gaps in traffic can be used to determine alternatives. The idea behind measuring the amount of gaps in traffic in a given subtask is that it allows for a measure of how many opportunities to make the left turn were presented. This information may be used in conjunction with the number of lanes data in order to give a more complete measure of alternatives. However, with an eye towards scalability, the number of alternatives may not always scale with the gaps in traffic in any scenario where driving across traffic is not necessary. In that case, another temporal alternatives feature must be found. It is important to measure the number of alternatives both spatially and temporally regardless of the driving situation.

Fundamentally, criticality is a subjective measurement and can be thought of as the expected value of the risk of not making a decision. That is, if risk is high in one subtask relative to the other subtasks, such as when going through an intersection, criticality is high in that subtask. In the specific case of the left turn, criticality is high when approaching the stop sign and when making the left turn. In this case, criticality is high when velocity is low, such as stopping at a stop sign and starting a turn. In that regard, criticality can be measured as the inverse of the velocity, in this specific scenario. However, criticality is the most scenario-specific complexity measure and in the case of highway driving, criticality may increase as speed increases or it may increase when slowing down to exit the highway. Thus, criticality will be very different in each situation and even within situations in each subtask.

A direct measure of perceptual complexity is weather. Perceptual complexity increases drastically in heavy snow or heavy fog conditions. Another measure of perceptual complexity is the number of objects that the sensors pick up. The idea behind measuring the number of objects seen by the car in a given subtask is that the more objects that the car has to interact with, the more complex the perception by that car has to be. This feature should be relatively scalable, although the weight may change based on the scenario. For example, the number of objects may be more important than the weather when crossing a busy intersection on a clear day but the number of objects may be less important when driving on a winding desolate road in snowy conditions.

Finally, the speed of the decision can be seen as the inverse of the total length of the subtask. The larger the amount of time that the driver is in a certain subtask, the longer the speed of the decision. This is tied to the velocity of the driver as well, with the larger the velocity, the lower the speed of the decision as the driver spends less time in the specific subtask. In terms of the complexity calculation for speed of decision, the amount of seconds in each subtask is calculated. Inherent in this calculation is velocity, so it is not explicitly factored into the speed of the decision. This feature is scalable: the speed of the decision is fundamentally found by taking the inverse of the length of the subtask the longer the subtask, the slower the speed of decision, given that subtasks are partitioned correctly.

The next step is to compare the calculated complexity scores with the subjective complexity scores created by a human. Complexity scores created by humans include error rate probabilities and familiarity, which are not accounted for in the calculated complexity scores. It is desirable to initially match the calculated complexity scores with the human created complexity scores in order to establish a baseline. So in order to match the calculated and created complexity scores the different subtask complexities are weighted and adjusted in order to better match the human scores. This process of comparing the algorithm-computed complexity scores to subjective human complexity scores will continue to occur as data is generated, with the process iterating back on itself to continue to fine tune the algorithm. Many human created complexity scores are aggregated and normalized in order to generalize the algorithm.

In order to determine correlation among subtasks or complexity categories and human complexity scores, the data is analyzed from a different perspective. Within a given scenario, the total complexity among complexity categories for subtask 1 is calculated. In an exemplary embodiment, the total complexity value is then divided by the total algorithm complexity score among all of the subtasks and then multiplied by 100. This gives a scaled feature that shows how much subtask 1 contributes to overall complexity for scenario 1. After the scaled complexity contributions for each subtask are calculated, the scores are further scaled within each subtask. That is, all of the subtask scores are then divided by the highest score of any subtask among all scenarios, to scale the results within the given subtask. The calculated complexity results are then compared to the human complexity scores. Similarly to the subtask scores, all of the human complexity scores are divided by the largest human complexity score among the subtasks, which allows for comparison by similar scaling.

Subtasks with a negative correlation with human complexity scores, such as approaching the stop sign and slowing down, are expected to be simple subtasks which do not greatly contribute to the overall complexity. So, it is expected that as the amount of complexity of a subtask contributes to overall complexity, it is a more complex subtask. For example, if slowing down when approaching a stop sign 1, which is the simplest subtask in making a left turn, is the primary contributor to the overall complexity, the task itself was not very difficult relative to other tasks.

The same analysis is repeated among all complexity categories. Each complexity category's total score is found among all subtasks in a given scenario. This score is then divided by the total complexity score for the scenario and then multiplied by 100. This calculation computes the relative percentage that the complexity category contributes to the total complexity in a given scenario. This calculation is repeated for every complexity category.

Using distributed simulation, the complexity measure of a traffic scenario can be automated and iterated rapidly to maximize the amount of scenario data available to the cognitive system. Parameters within simulation, such as traffic density, can be manipulated as needed, and parameter sweeping can be utilized to rapidly generate traffic scenarios in a wide range of complexity scores. Many thousands of variations of complexity scenarios can then be run simultaneously on distributed cluster hardware to populate the episodic memory of the cognitive learning model to expose it to a rich array of episodes that will guide driving behavior.

Returning to the exemplary embodiment, four stages of a left turn scenario in which complexity measures change as the self-vehicle proceeds during the turn. In the S1 phase, the car is stationary and actions are limited to go/no go. In this stage, the criticality and perceptual difficulty of the task may be altered through addition or subtraction of simulation assets such as pedestrians or parked cars that represent critical elements the prevent action, or visual obstruction/obfuscation that creates additional complexity in proceeding to S2. These elements can be scripted in order to automatically generate many situational instances that greatly diversify the conditions of S1. Similarly, the complexity Of S2 can be modified by altering the speed of cross traffic, density of traffic, or type of traffic, such as truck vehicle types that limit visual range, in automated fashion. S3 can be modified by the same, but also contain automation that adjusts the aggressiveness of cross traffic or the consistency of cross traffic. Finally, the complexity Of S4 may be modified by such factors as sudden braking, road type, merging behaviors of non-self-vehicles and the presence of “surprise” obstructions, such as road debris, lane visibility, etc. Parameters that affect global decision-making, such as the presence of additional lanes, special lanes, construction, or other likely road-going scenarios are all additional elements that is suitable for automation. Through modification of these experimental variables, there is the potential to generate thousands of permutations of a given traffic episode that will provide rich training data for the cognitive system. This rapid iteration of traffic variables, and the parallelized, cluster-based simulation of both self- and non-self vehicle actions is the key to furnishing the cognitive model with extensive training data beyond what is feasible through real-world driving alone. The benefits of this approach are complete parametric control over environmental and vehicle situations and traffic behavior. This facilitates the testing of edge cases safely while systematically modifying the model parameters to enable the ability to monitor whether the cognitive architecture performs at or beyond the capabilities of the best human drivers.

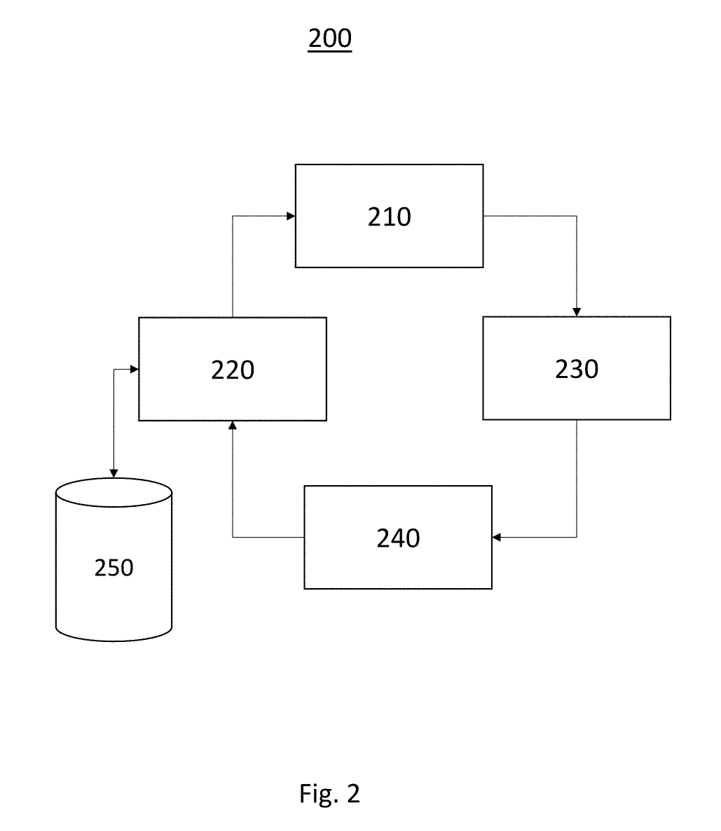

Turning now to FIG. 2, an exemplary apparatus 200 for implementing the method for autonomous system performance metric generation and benchmarking is shown. The apparatus 200 is operative to simulate a driving scenario for evaluation and quantifying the performance of a driving system, including an autonomous driving system. The apparatus is used of quantify the cognitive cost and effort required by a driver, or driving system, to successfully complete the scenario. The apparatus comprises a simulator 220, a sensor interface 210, a control system interface 240 and a memory 250. The sensor interface 210 and the control system interface 240 are operative to interact with the vehicle control system. The apparatus may be implemented in hardware, software or a combination of both.

The simulator 220 is operative to simulate the driving environment and scenario and generate control signs for controlling the sensor interface 210. The sensor interface 210 is operative to generate sensor signals that are readable by the vehicle control system 230. The sensor signals interface with a way with the vehicle control system 230 such that it appears to the vehicle control system that it is operating in the actual environment. The control system interface 240 receives control signals generated by the vehicle control system 230. The control system interface 240 translates these control signals into data used by the simulator 220 as feedback from the scenario. The scenarios are stored on the memory 250 which is accessed by the simulator. The simulator is further operative to store additional information and updates to the scenarios and complexity metrics on the memory 250.

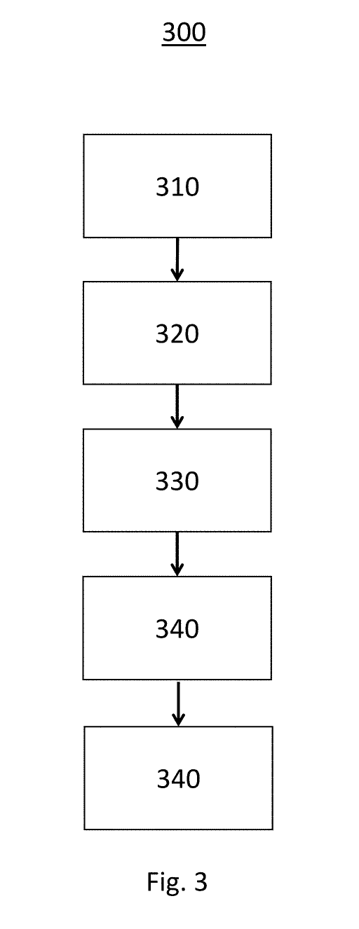

Turning now to FIG. 3, an exemplary method for autonomous system performance metric generation and benchmarking 300 is shown. The method is first operative to receive a driving scenario 310. The scenario may be received in response to a control signal generated by the simulator or may be received from a separate controller source. The method is then operative to segment the the driving scenario into a a plurality of tasks 320. For example, in the previously described left hand turn scenario, the scenario is segmented into four subtasks. The method is then operative to assign a complexity to each of the subtasks 330. The next step is to generate an overall complexity in response to assigned task complexities 30. The overall complexity is then compared to a human complexity 340 to generate a comparison metric. The method then weights the various subtask complexities 350 in response to the comparison such that the overall complexity correlates with the human complexity to generate an updated overall complexity. Finally, the method evaluates the driver performance in response to the updated overall complexity 360. Again, the driver may be a human driver, a partial assist autonomous driving system or a fully autonomous driving system.

1. An apparatus comprising:
a sensor interface for generating sensor data for coupling to a vehicle control system;
a control system interface for receiving control data from the vehicle control system;
a memory for storing a first scenario having a first overall complexity wherein the first scenario is divided into a first subtask and a second subtask and wherein the first subtask has a first complexity and the second subtask has a second complexity and wherein the first overall complexity is determined in response to the first complexity and the second complexity; and
a simulator for simulating a driving environment in response to the first scenario and the control data, the simulator further operative to control the sensor interface and to generate performance data in response to the control data.

2. The apparatus of claim 1 wherein the first complexity and the second complexity are weighted in response to a human complexity such that the first overall complexity correlates with the human complexity.

3. The apparatus of claim 1 wherein the memory is operative to store a second scenario having a second overall complexity.

4. The apparatus of claim 1 wherein the apparatus is implemented in software.

5. The apparatus of claim 1 wherein the apparatus is implemented in hardware.

6. The apparatus of claim 1 wherein the simulator is further operative to generate a success rate in response to the performance data.

7. The apparatus of claim 1 wherein the vehicle control system is an autonomous vehicle control system.

8. A method comprising:
receiving a driving scenario;
segmenting the driving scenario into a first task and a second task;
assigning a first complexity to the first task and a second complexity to the second task;
generating an overall complexity in response to the first complexity and the second complexity;
comparing the overall complexity to a human complexity;
weighting the first complexity and the second complexity in response to the comparison such that the overall complexity correlates with the human complexity to generate an updated overall complexity; and
evaluating a driver performance in response to the updated overall complexity.

9. The method of claim 8 wherein the driver performance is determined in response to a deviation of a behavioral measure from an ideal measure.

10. The method of claim 8 comprising altering a condition of the first task and adjusting the updated overall complexity in response to the condition.

11. The method of claim 8 further comprising collecting a percept and determining the driver performance in response to the percept.

12. The method of claim 8 wherein the first complexity is determined in response to a first event and a second event wherein the first event and the second event represent phenomena within the first task.

13. The method of claim 12 wherein the first event is a weather event and the second event is a traffic congestion event.

14. The method of claim 8 wherein the updated overall complexity is used to generate a cognitive model for a vehicle control system.

15. The method of claim 8 wherein the first complexity is determined in response to a third complexity assigned to a third task wherein the third task is a segment of an alternative scenario and the third task is similar to the first task.

16. A method comprising:
receiving a driving scenario;
segmenting the driving scenario into a first task and a second task;
generating a first complexity in response to a first human response to the first task and generating a second complexity in response to a second human response to the second task;
generating an overall complexity in response to the first complexity and the second complexity;
weighting the first complexity and the second complexity such that the overall complexity correlates with an overall human complexity to generate an updated overall complexity; and
evaluating a driver performance in response to the updated overall complexity.

17. The method of claim 16 wherein the driver performance is determined in response to a deviation of a behavioral measure from an ideal measure.

18. The method of claim 16 comprising altering a condition of the first task and adjusting the updated overall complexity in response to the condition.

19. The method of claim 16 further comprising collecting a percept and determining the driver performance in response to the percept.

20. The method of claim 16 wherein the first complexity is determined in response to a first event and a second event wherein the first event and the second event represent phenomena within the first task.
